(19) United States
(12) Patent Application Publication
(10) Pub. No.: US 2005/0128879 A1
(43) Pub. Date: Jun. 16, 2005

(54) Timer

(76) Inventors: Charles Sanford, Northbrook, IL (US); Todd Studebaker, Bartlett, IL (US)

Correspondence Address: BRINKS HOFER GILSON & LIONE, P.O. BOX 10395, CHICAGO, IL, 60610, US

(21) Appl. No.: 10/737,701

(22) Filed: Dec. 15, 2003

(51) Int. Cl. G04F 10/00

(52) U.S. Cl. 368/109

(57) ABSTRACT

In one embodiment, a timer is disclosed having at least one switch, an alarm, a display device, and a controller. The controller starts a countdown sequence in response to activation of a switch, the countdown sequence having at least one time interval. The controller then activates an alarm at an end of the countdown sequence and at each of the at least one time interval. As well, the controller displays a number of substantially completed countdown sequences on the display device in response to activation of a switch. Other embodiments are discussed, and each can be used alone or in combination with one another.

### BACKGROUND

After injury or a prolonged period of inactivity, patients may enter a long process of recovery in order to regain their physical strength, flexibility, and mobility. Upon the advice and with the assistance of a doctor or a physical therapist, these patients may perform series of exercises in order to further this recovery process.

Such exercises may be performed with or without an assisting physical therapy device, and these exercises may be performed in a variety of sets and repetitions. Furthermore, the exercise sets may be performed for particular lengths of time. For example, a patient may perform a particular exercise with his right arm for five minutes, then his left arm for another five minutes. Depending on the recommendation of his doctor or therapist, a patient may rest for a period of time in between sets or perform another set immediately. This pattern of exercise and rest time intervals may continue for a specified length of time as well. In the previous example, the patient may perform the exercises for five minutes at a time with each arm, for a total of six sets. Without rest periods, this would correspond to a thirty-minute workout.

Among physical therapy devices, some electrical physical therapy devices provide a timing mechanism for assisting a patient in performing his assigned therapy regimen. These electrical devices may operate by direct electrical stimulation of the muscles of a patient for predetermined time intervals or for a total time duration. In such a situation, the patient would not need to perform any sort of adjustment or further action: the device performs the therapy routine to completion without active patient involvement.

Other electrical devices, such as a treadmill, may provide an interactive exercise routine for a patient. A treadmill may provide a preprogrammed routine of varying difficulty for a period of time. In this case, the patient responds to the routine presented by the treadmill, but the treadmill is relied upon to provide the exercise routine—for instance, to raise or lower the incline of the treadmill surface or to increase or decrease the speed at which the treadmill surface moves.

In many physical therapy situations, though, no electronic automation is provided with a therapy routine or therapy device. For instance, a therapist may provide a patient a static progressive stretch device. In such a case, the therapist may request that the patient perform a series of six pain-free stretches of five minutes each, for a total of thirty minutes of stretching. After each five-minute stretch, the patient may be advised to adjust the range of motion of the device to ensure that the next five-minute stretch remains at the same pain-free level as the previous stretch. In this case, a patient may be asked to perform three thirty-minute stretching sequences each day for a number of days.

In order to measure and track these stretches and stretching sequences, the therapist may provide a timer for the patient to use. The timer may be set to a particular duration—such as five minutes—to count down from five minutes to zero minutes, and then, to alarm once it reaches zero. In an example case of a prescribed course of therapy of six stretches of five minutes each, after the first stretch, the patient may pick up the timer, turn off the timer alarm, manually reprogram the timer to five minutes, adjust his physical therapy device, start the timer, and begin a second stretch. The patient would need either to keep an accurate mental tally of the number of stretches he has performed or to have a clock available to provide him with a rough idea of how many stretches he has performed in each stretching session. Particularly for older patients or for those performing more physically demanding therapy exercises, this mental tally may be difficult to maintain and recall accurately.

Then, the patient would need to recall how many therapy sessions he has performed in a particular day. For a ten-day therapy regimen of three stretching sessions of six stretches per day, a patient would need to remember the number of sessions performed at least thirty times and remember the number of stretches he has performed at least one hundred eighty times. For longer therapy regimens, these numbers would increase.

When the patient returns to his doctor or therapist for a checkup, the doctor or therapist may ask generally whether the patient performed the prescribed course of therapy. The regimen will only be as effective as the patient's desire to maintain it, and a general question about whether the patient was faithful to the prescribed regimen will likely be answered, “yes,” whether the patient performed all the exercises, forgot a few exercises, or did not perform any of the exercises.

This may prove particularly problematic in the situation of on-the-job injury, where workman's compensation may require that an injured employee follow a prescribed physical therapy regimen in order to be compensated for his injuries. In these situations, thousands of dollars may be at stake over the question of whether or not a patient has performed his prescribed exercises.

### BRIEF SUMMARY

The present invention is defined by the following claims, and nothing in this section should be taken as a limitation on those claims.

In one embodiment, a timer including at least one switch, an alarm, a display device, and a controller is disclosed. The controller is operative to display a number of completed countdown sequences in response to activation of a switch. The controller is also operative to start a countdown sequence in response to activation of a switch. The controller is further operative to activate an alarm at each of the at least one time interval and at an end of the countdown sequence. The completed countdown sequences display operation may be in response to a different type of switch activation than that of the countdown sequence start operation.

In another embodiment, a timer is disclosed which has a controller operative to alter the at least one time interval in response to activation of a switch. The controller may also be operative to alter a duration of the countdown sequence or display the number of completed countdown sequences in response to activation of at least one switch. Each of these operations may be dependent upon activation of another switch.

In yet another embodiment, a timer is disclosed which has a controller operative to reset the countdown sequence in response to activation of a switch. The controller may also be operative to display a number of completed countdown sequences. The completed countdown sequences display operation may be in response to a different type of activation than that of the countdown sequence reset operation activation. As well, each of the timers disclosed may be used in combination with a physical therapy device, and they may feature an attachment element.

Other embodiments are disclosed, and each can be used alone or in combination with one another.

### BRIEF DESCRIPTION OF SEVERAL VIEWS OF THE DRAWINGS

FIG. 1 illustrates a block diagram of a timer.

FIG. 2 illustrates a front view of a timer.

FIG. 3 illustrates a back view of a timer.

FIG. 4 illustrates a flow-chart of exemplary timer operation steps.

FIG. 5 illustrates a flow-chart of exemplary timer operation steps.

FIG. 6 illustrates a flow-chart of exemplary timer operation steps.

### DETAILED DESCRIPTION OF THE INVENTION

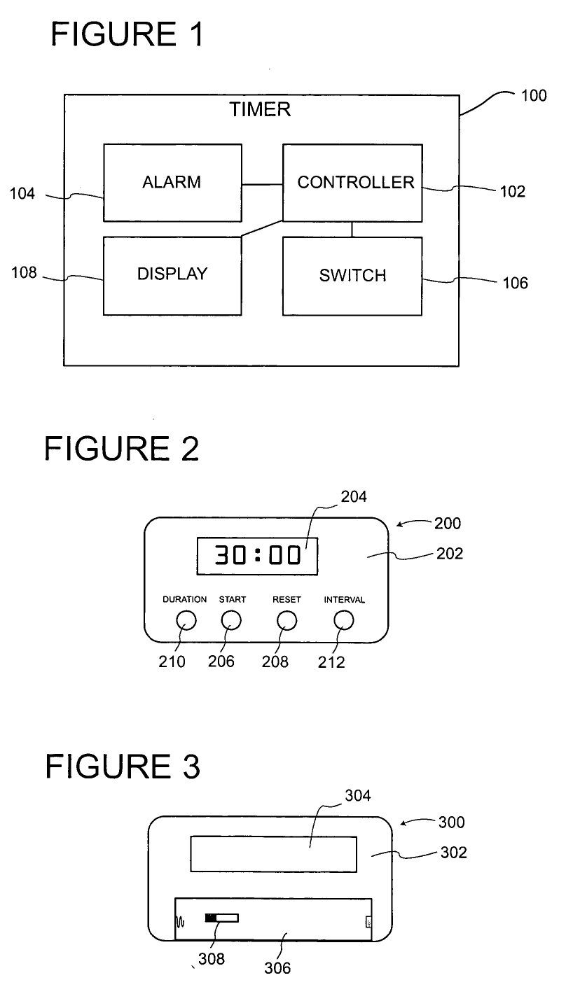

Turning to FIG. 1, it discloses a timer 100 having a controller 102, an alarm 104, at least one switch 106, and a display 108. The timer 100 may be a self-contained unit, a component in or attached to a larger electronic device, a component in a computer, a remote network-accessible timer, a component part in a physical therapy device, or other type of timer. The timer 100 may, for example, be based on the platform of the Invisible Clock®, available from the Time Now Corporation. The controller 102 may comprise electronic circuitry, program code instructions, a computer, data storage media, or other devices or code that may control timer operation. The alarm may comprise any number of alarms, such as an audible alarm, a visual alarm, a vibrating alarm, a computer alarm, a program code-generating alarm, or other alarm. The alarm 104 may produce an indicator, such as an audible beep or ring, a spoken message, an audible song, a flashing light, a steady light, vibration, a written message, a Braille message, a pop-up window, a program code output, a computer data output, or other indicator. The at least one switch 106 may comprise at least one push button, pull button, twisting knob, keypad, flippable switch, touch-sensitive pad, squeeze handle, motion detector, heat sensor, remote control switch, computer-operated switch, remote network switch, dial, joystick, other device, or any combination thereof. The display 108 may comprise a liquid-crystal display, a television, a computer monitor, a manual display, a remote network display, or other display.

Turning to FIG. 2, it discloses a front view of an exemplary timer 200. The timer 200 has a housing 202 which may come in a variety of sizes, for example, two inches by one and one-half inches. The housing 202 in the embodiment shown is rectangular with rounded edges, but the housing 202 may have rounded or pointed edges and may be circular, a polygon shape, or some other shape. The timer 200 has a display 204 and four buttons 206, 208, 210, 212. In the embodiment of FIG. 2, button 206 is a “START ” button, button 208 is a “RESET” button, button 210 is a “DURATION” button, and button 212 is an “INTERVAL” button. Though four buttons are used in this example, any number or combination of switches may be used to implement a timer.

In this example, the start button 206 may be pressed once to turn on the timer. The start button 206 may also be pressed once to start a countdown sequence or to pause a countdown sequence in progress. At any time during the countdown sequence or after it has ended, the reset button 208 may be pressed to reset the countdown sequence. In this example, if the start button 206 is pressed and held for ten seconds, a number of completed countdown sequences will be displayed on the display 204. In this embodiment, during this display, the number of completed countdown sequences may be reset to zero by pressing the reset button 208. As an additional feature during this display, the start button 206 may be pressed and held for five more seconds to save the number of completed countdown sequences at that point in time. The timer 200 may indicate such a saving by displaying the word “SAVED” on the display 204. As well, the timer 200 may automatically save the number of completed countdown sequences in a variety of ways including, for example, using a RAM chip, a battery, or some other device. Particularly, these variety of ways may allow the timer 200 to retain the number of completed countdown sequences—or other timing feature information—even if the timer should lose its power source or have its power interrupted, such as if a timer battery were removed.

Turning to FIG. 3, it discloses a back view of an exemplary timer 300. The timer 300 has a housing 302. An attachment element 304 is secured to the back of the housing 302. The attachment element 304 may be used to attach the timer to another object, such as a wall, countertop, or shelf, an article of clothing or a wristband, or a physical therapy device or other device. The attachment element 304 may comprise, for example, Velcro, an adhesive material such as adhesive putty or adhesive tape, or a belt clip or other type of clip. The physical therapy device may be, for example, a static progressive stretch device, as described above. A battery compartment 306 is located within the housing 302 and has a battery cover (not shown) and battery (not shown). Inside the battery compartment 306 of this embodiment is a flippable switch 308. An exemplary use of the flippable switch 308 is to allow or disallow alterations to a timer countdown sequence in response to the activation of the flippable switch 308. The flippable switch 308 may, for example, be located on the housing 302 or be located within the housing 302. This particular embodiment illustrates the configuration where the flippable switch 308 is located within the housing 302.

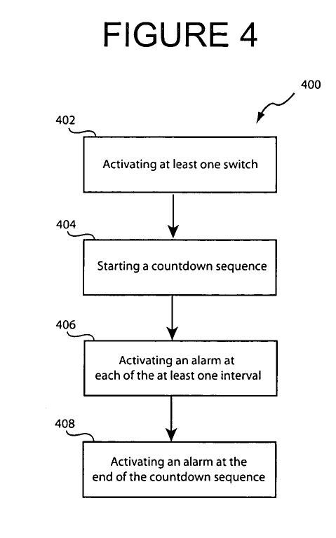

Turning to FIG. 4, it discloses a sequence of operation steps 400 of a timer, such as the timer 100 of FIG. 1. First, at least one switch is activated in step 402. In response to the activation of step 402, a controller starts a countdown sequence in step 404. The end of the countdown sequence may correspond to a round number of minutes, such as thirty minutes, or any other length of time. The countdown sequence may also comprise at least one time interval. The at least one interval may be a single interval, such as a fifteen minute interval, or a plurality of intervals, such as five, ten, fifteen, twenty, and twenty-five minute intervals. In step 406, the controller activates an alarm at each of the at least one interval. Finally, at step 408, the controller activates an alarm at the end of the countdown sequence.

An exemplary sequence of the operation steps 400 may proceed as follows: First, a start switch is activated. In response to the activation of the start switch, a controller starts a countdown sequence. The countdown sequence used here may be of thirty minutes in length, with intervals at five, ten, fifteen, twenty, and twenty-five minutes. The controller directs activation of an alarm at each of the five-minute intervals, and then, the controller directs activation of an alarm at thirty minutes, the end of the countdown sequence. These alarms may comprise any of a variety of alarms. For example, the controller may activate a single beep at each of the at least one interval and may activate a continuous series of beeps at the end of the countdown sequence. In one embodiment, the controller may activate the continuous series of beeps until the start switch is activated or a particular amount of time has passed.

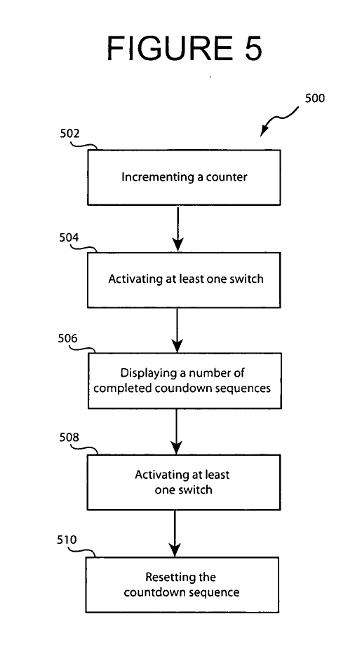

Turning to FIG. 5, it discloses a sequence of operation steps 500 for an exemplary timer of the present invention. These operation steps 500 may, but are not required to, follow the operation steps 400 of FIG. 4. In response to the end of a countdown sequence, the controller increments a counter in step 502. In this example, the counter is an internal feature of the controller and maintains a number of completed countdown sequences. Step 504 discloses the activation of at least one switch. In response to the activation of step 504, the controller displays the number of completed countdown sequences on a display device in step 506. After this, at least one switch is activated in step 508. In response to the activation in step 508, the controller resets the countdown sequence in step 510. In an exemplary embodiment, this reset may be indicated on the timer display and accompanied by an audible indicator, such as a beep. The reset of step 510 may also comprise readying the timer and controller to start another countdown sequence.

While the step 502 of incrementing a counter may be performed in response to the end of a countdown sequence, the incrementing step 502 may also be performed in response to the passing of a predetermined portion or amount of the countdown sequence. For instance, the counter may increment after one half or one quarter of the countdown sequence has passed or after five or ten minutes of the countdown sequence has passed. This may allow an individual patient who is unable to complete the full countdown sequence to receive credit for a good faith effort. Depending on the habits or needs of the patient or user population, a credit duration may be set, at which credit is given for a substantially completed countdown sequence. This credit duration may be expressed as a percentage of the duration of the countdown sequence or as a particular amount of time. In an exemplary embodiment, the credit duration may be set by doctor or therapist. In this way, those users or patients who start and quickly reset the timer—in the hopes that the timer will increment merely in response to the reset—will be thwarted in their efforts to deceive their doctor or therapist. Even so, use of a credit duration, or modification of a credit duration by a doctor or therapist, is not required of the timer.

The activation of step 504 may be any type of activation. For example, one type of activation may be an activation of a single switch for a brief period of time—e.g., a quick button press and release. Another type of activation may be an activation of a single switch for a predetermined time interval—e.g., a button press for five seconds. A further type of activation may be an activation of a single switch in a sequence—e.g., three quick button press and releases or a quick button press and release followed by a button press for three seconds. Yet another type of activation may be an activation of a plurality of switches in unison for a brief period of time—e.g., a quick press and release of two buttons. An additional type of activation may be an activation of a plurality of switches in unison for a predetermined time interval—e.g., a press of two buttons for five seconds. Yet a further type of activation may be an activation of a plurality of switches in a sequence—e.g., a quick press and release of a first button followed by a quick press and release of a second button, a series of quick press and releases of any number of buttons, or a series of quick press and releases interspersed with button presses of several seconds. In an exemplary timer of the present invention, different types of activations may be used to trigger different responses in the timer. For instance, the step 504 activation may be an activation of a single switch for a predetermined time interval, while the step 402 activation may be an activation of a single switch for a brief period of time.

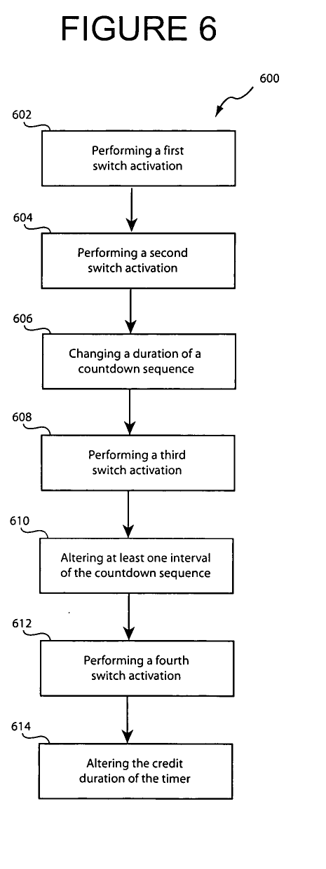

Turning to FIG. 6, it discloses a series of operation steps 600 for an exemplary timer of the present invention. These steps 600 may, but are not required to, follow the steps 400, 500 of FIGS. 4 or 5. A first switch activation is performed in step 602. In step 604, a second switch activation is performed. In response to the second switch activation 604 and the first switch activation 602, the controller changes a duration of a timer countdown sequence in step 606. Next, in step 608, a third switch activation is performed. In response to the third switch activation 608 and the first switch activation 602, the controller alters at least one interval of the countdown sequence in step 610. Further, in step 612, a fourth switch activation is performed. In response to the fourth switch activation 612 and the first switch activation 602, the controller alters the credit duration of the timer in step 614.

In each of these switch activations 602, 604, 608, 612, any combination of one or more switches may be used. For instance, the different switch activations may be performed on distinct switches, performed on the same switches in a variety of activations and sequences of activation, or performed on the same switches at different times—such as during a programming mode or a menu programming mode.

An example of the operation of steps 600 may be implemented as follows: The first switch activation 602 may be activation of a first general activation switch, such that the first general activation switch must be activated in order to start a programming mode during which certain timing features may be changed. For example, this first general activation switch may be implemented as flip switch 308, as discussed above. Alternately, a plurality of switches may serve to perform the first switch activation, such that the activation of a plurality of switches in unison for a predetermined time interval may cause the timer to enter the programming mode.

In this way, a patient would not accidentally perform first switch activation 602—and thereby allow certain timing features to be changed—while the timer is in use. As well, the first general activation switch may be placed so that the patient is not able to easily locate or access the switch, such that the patient may not be able to alter desired treatment timing features.

In the example of FIG. 6, the timing features to be altered are the countdown sequence duration, the interval timing within the countdown sequence, and the credit duration. Thus, when step 604, step 608, or step 612 are performed, the controller changes the respective duration or interval only if first switch activation 602 has occurred. First switch activation 602 may be, for example, a singular activation or a continuing one. For instance, in a singular first switch activation 602, a user may press and release a button—either quickly or for a predetermined time interval—to enter the programming mode. Then, the user may make a desired alteration. Afterwards, the timer may automatically resume a normal operation mode, during which alterations may not occur, or a user may need to press a button to return to the normal mode from the programming mode. Or, in a continuous first switch activation 602, a user may, for example, activate a switch by flipping it from a normal operation mode setting to a programming mode setting. Then, the user may make the desired alterations, after which the user flips the switch from the programming mode setting back to the normal operation mode setting.

As a further alternative, first switch activation 602 may generate a menu programming mode that provides a user-friendly interface for altering the time interval, countdown sequence duration, credit duration, or other timing feature. Such a menu may include an ability to scroll—in response to switch activation—between the timing features able to be altered. For example, a fifth and sixth switch activation may provide scrolling up and down, respectively, of menu options. This menu may include an indication on the display 204 of the particular feature to be altered at that time, such as a letter or word associated with the feature, a number associated with the feature, or another indication specific to the feature on the display 204 or the timer 200.

Even so, the first switch activation 602 is not a required part of the timer of the present invention, and this step 602, if included, may be executed and responded to in a variety of ways, a few of which were mentioned above. Further, steps 604, 606; steps 608, 610; and steps 612, 614 may be performed exclusively, performed in any order, or each performed with or without the functionality of the first switch activation 602. For example, a timer of the present invention may only have the functionality of the second switch activation 604 and not the third switch activation 608. The features shown in FIG. 6 may be included, in any of the variety of ways mentioned above, with any of the other features disclosed in this specification, as well.

It is to be understood that changes and modifications to the embodiments described above will be apparent to those skilled in the art, and are contemplated. It is therefore intended that the foregoing detailed description be regarded as illustrative rather than limiting, and that it be understood that it is the following claims, including all equivalents, that are intended to define the spirit and scope of this invention.

1. A timer comprising:
at least one switch;
an alarm;
a display device; and
a controller;
wherein the controller is operative to start a countdown sequence in response to activation of one of the at least one switch, the countdown sequence comprising at least one time interval;
wherein the controller is further operative to activate the alarm at an end of the countdown sequence and at each of the at least one time interval;
wherein the controller is further operative to display a number of substantially completed countdown sequences on the display device in response to activation of one of the at least one switch.

2. The timer of claim 1, wherein the activation of the one of the at least one switch to which the display of substantially completed countdown sequences is responsive is a different type of activation than the activation of the one of the at least one switch to which the start of the countdown sequence is responsive.

3. The timer of claim 2, wherein the controller is further operative to display the number of substantially completed countdown sequences on the display device in response to activation of the one of the at least one switch for a predetermined time interval.

4. The timer of claim 2, wherein the controller is further operative to display the number of substantially completed countdown sequences on the display device in response to activation of a plurality of the at least one switch.

5. The timer of claim 2, wherein the controller is further operative to display the number of substantially completed countdown sequences on the display device in response to activation of a plurality of the at least one switch for a predetermined time interval.

6. The timer of claim 2, wherein the controller is further operative to display the number of substantially completed countdown sequences on the display device in response to activation of a plurality of the at least one switch in a predetermined sequence.

7. The timer of claim 1, wherein the controller is further operative to alter the at least one time interval in response to activation of at least one of the at least one switch.

8. The timer of claim 1, wherein the controller is further operative to alter a time duration of the countdown sequence in response to activation of at least one of the at least one switch.

9. The timer of claim 1, in combination with a physical therapy device.

10. The timer of claim 1, further comprising a power source, wherein the controller is further operative to save the number of substantially completed countdown sequences when the power source is disconnected from the timer.

11. A timer comprising:
at least one switch;
an alarm;
a display device; and
a controller;
wherein the controller is operative to start a countdown sequence in response to activation of one of the at least one switch, the countdown sequence comprising at least one time interval;
wherein the controller is further operative to activate the alarm at an end of the countdown sequence and at each of the at least one time interval;
wherein the controller is further operative to alter the at least one time interval in response to activation of one of the at least one switch.

12. The timer of claim 11, wherein the controller is operative to alter the at least one time interval in response to activation of the one of the at least one switch only when a different one of the at least one switch is activated.

13. The timer of claim 12, wherein the controller is operative to enter a menu programming mode in response to activation of the different one of the at least one switch.

13. The timer of claim 11, wherein the controller is further operative to alter a duration of the countdown sequence in response to activation of one of the at least one switch.

14. The timer of claim 13, wherein the controller is further operative to display a number of substantially completed countdown sequences on the display device in response to activation of one of the at least one switch.

15. The timer of claim 13, wherein the controller is operative to alter a) the at least one time interval in response to activation of the one of the at least one switch and b) the duration in response to activation of the one of the at least one switch, only when a different one of the at least one switch is activated.

16. The timer of claim 15, the timer further comprising a housing, wherein the different one of the at least one switch is located within the housing.

17. The timer of claim 11, further comprising a physical therapy device attachment element.

18. A timer comprising:
at least one switch;
an alarm;
a display device; and
a controller;
wherein the controller is operative to start a countdown sequence in response to activation of one of the at least one switch, the countdown sequence comprising at least one time interval;
wherein the controller is further operative to activate the alarm at an end of the countdown sequence and at each of the at least one time interval;
wherein the controller is further operative to reset the countdown sequence in response to activation of one of the at least one switch.

19. The timer of claim 18, wherein the controller is further operative to display a number of substantially completed countdown sequences on the display device in response to activation of one of the at least one switch.

20. The timer of claim 19, wherein the activation of the one of the at least one switch to which the display of substantially completed countdown sequences is responsive is a different type of activation than the activation of the one of the at least one switch to which the reset of the countdown sequence is responsive.

21. The timer of claim 20, wherein the controller is further operative to display the number of substantially completed countdown sequences on the display device in response to activation of the one of the at least one switch for a predetermined time interval.

22. The timer of claim 20, wherein the controller is further operative to display the number of substantially completed countdown sequences on the display device in response to activation of a plurality of the at least one switch.

23. The timer of claim 20, wherein the controller is further operative to display the number of substantially completed countdown sequences on the display device in response to activation of a plurality of the at least one switch for a predetermined time interval.

24. The timer of claim 20, wherein the controller is further operative to display the number of substantially completed countdown sequences on the display device in response to activation of a plurality of the at least one switch in a predetermined sequence.

25. The timer of claim 18, wherein the controller is further operative to store a number of substantially completed countdown sequences, and
wherein the controller is further operative to increment the number of substantially completed countdown sequences in response to completion of a predetermined part of the countdown sequence.

26. The timer of claim 25, wherein the controller is further operative to alter the predetermined part of the countdown sequence in response to activation of at least one of the at least one switch.

27. The timer of claim 26, wherein the predetermined part of the countdown sequence is denoted as a percentage of the countdown sequence.

28. The timer of claim 26, wherein the predetermined part of the countdown sequence is denoted as an amount of time.

29. The timer of claim 18, in combination with a physical therapy device.
